(19) United States
(12) Patent Application Publication
(10) Pub. No.: US 2015/0314196 A1
(43) Pub. Date: Nov. 5, 2015

(54) DEPLOYMENT OF AN ELECTRONIC GAME USING DEVICE PROFILES

(71) Applicant: MPH, Inc., San Francisco, CA (US)

(72) Inventors: Adam Cory Chapman, Los Angeles, CA (US); Jeffrey Norman Grills, Austin, TX (US); Brandon Michael Bare, Austin, TX (US)

(21) Appl. No.: 14/701,344

(22) Filed: Apr. 30, 2015

Related U.S. Application Data
(60) Provisional application No. 61/987,230, filed on May 1, 2014.
(60) Provisional application No. 61/987,240, filed on May 1, 2014.
(60) Provisional application No. 61/987,262, filed on May 1, 2014.
(60) Provisional application No. 61/987,273, filed on May 1, 2014.
(60) Provisional application No. 61/987,284, filed on May 1, 2014.

(51) Int. Cl. A63F 13/35; A63F 13/63

(52) U.S. Cl. CPC A63F 13/35; A63F 13/63

(57) ABSTRACT

A database-driven collaborative game development environment and system automatically generates runtime versions of a game for deployment on a plurality of different platforms based on predefined device profiles.

### CROSS REFERENCE TO RELATED APPLICATIONS

This application claims the benefit of U.S. Provisional Application No. 61/987,230 entitled “Decoupled Form and Content for Rich Media Development and Deploying Enabled By Database-Drive Rich Media Authoring Tool with Robust Device Profiles,” filed on May 1, 2014 to Adam Chapman, et. al, U.S. Provisional Application No. 61/987,240 entitled “Post Deployment Asset Updates Enabled By Runtime Packaging From Database-Drive Rich Media Authoring Tool,” filed on May 1, 2014 Christopher F. Mayer, et. al., U.S. Provisional Application No. 61/987,262 entitled “Bulk Data Field,” filed on May 1, 2014 to Jeffrey N. Grills, et. al., U.S. Provisional Application No. 61/987,273 entitled “Multi-Stage Data Parallel With Immediate Mode Insertion,” filed on May 1, 2014 to Randy D. Culley, et. al., and U.S. Provisional Application No. 61/987,284 entitled “Task Scheduling VM,” filed on May 1, 2014 to Kelly R. Brock, et. al. The content of each of the above are incorporated by reference in their entirety.

### BACKGROUND

1. Field of Art

The disclosure generally relates to a collaborative development system for creating electronic games.

2. Description of the Related Art

Game engines currently are built and optimized for a specific runtime environment (platform; e.g. xBox, PS4, PC, iPhone) due to content and form being tied together in traditional file-based systems. This means game developers essentially have to recreate large portions of their game every time they want to deploy to a new platform; e.g. on version for iPad, one for iPhone, one for Samsung Galaxy, one for Kindle Fire, one for PC, etc. As the number of available platforms grows, the deployment process becomes significantly more challenging.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 is a system diagram illustrating an embodiment of a collaborative game development environment.

FIG. 2 is a flowchart illustrating a process for converting electronic assets for an electronic game for deployment on a plurality of different deployment platforms.

FIG. 3 illustrates one embodiment of components of an example machine able to read instructions from a non-transitory machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A Database-driven collaborative game development environment and system automatically generates runtime versions of a game for deployment on a plurality of different platforms based on predefined device profiles. The development system allows developers to develop, package and publish to the multiple platforms with optimized runtime (based on device profiles) simultaneously thus improving efficiency and time to market.

A database-driven collaborative game development environment and system provides detailed tracking of changes made to an electronic game by multiple remote developers. Changes are tracked based on, for example, the developer making the change, the time of the change, and type of change. The system aggregates the data on a cloud server and then presents analytical data in a manner useful for tracking managing development of the electronic game. The data is tracked objectively and may be displayed in real time, allowing managers to see exactly how their game development team or individual employees are performing. This data may be also used to objectively report team or individual productivity or to subjectively analyze and optimize productivity.

One embodiment of a disclosed system, method and non-transitory computer readable storage medium includes deploying an electronic game to multiple gaming platforms. A plurality of digital assets associated with an electronic game are received at a server, where each of the digital assets in a format native to a digital content creation tool. The server converts the plurality of digital assets from the format native to the digital content creation tool to a generic format. The server receives a plurality of platform profiles, where each of the platform profiles associated with respective different types of platforms for deploying the electronic game, and each of the platform profiles specifying platform-specific modification rules for modifying the plurality of digital assets. The server modifies the plurality of digital assets according to each of the platform-specific modification rules to generate a plurality of sets of modified digital assets, each of the sets associated with one of the different types of platforms for deploying the electronic game. The server then generates a plurality of runtime versions of the electronic game, each of the plurality of runtime versions using a corresponding one of the sets of the plurality of assets, where each of the runtime versions associated with one of the different types of platforms for deploying the electronic game.

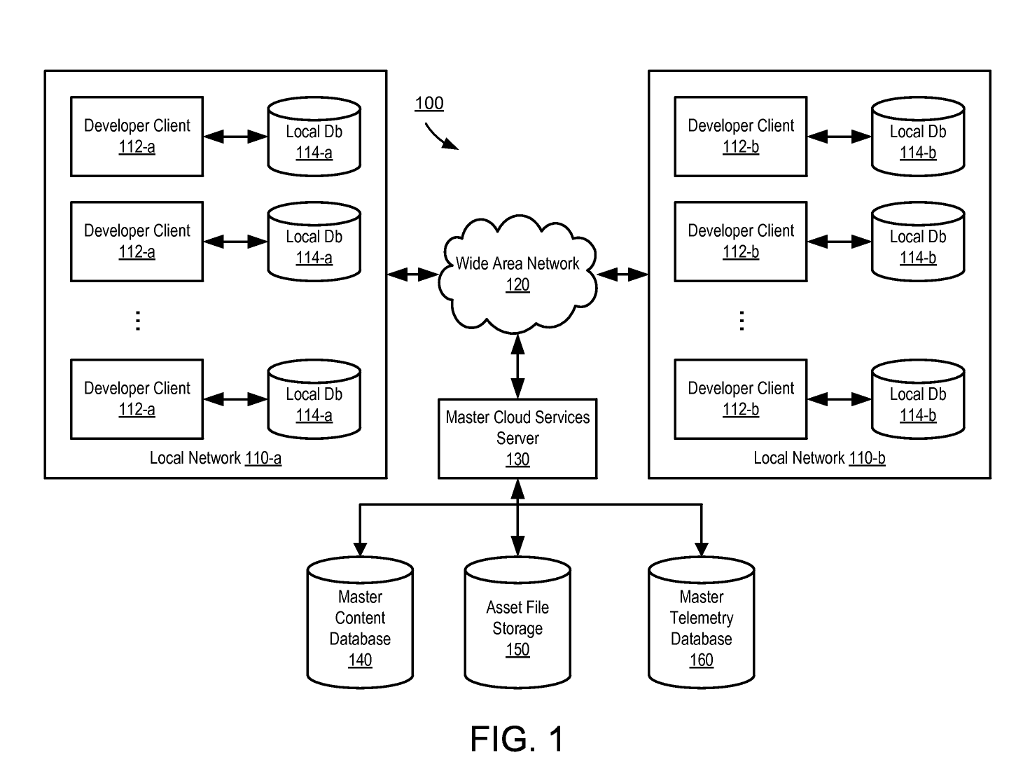

FIG. 1 illustrates an embodiment of a collaborative game development system 100 for developing digital games for platforms such as, for example, gaming consoles, PCs, tablets, and mobile devices. The collaborative game development system 100 enables multiple game developers, potentially working in different remote locations, to collaboratively develop a game. Furthermore, the collaborative game development environment enables managers to effectively manage, track, and generate reports detailing progress of the game under development. Furthermore, the collaborative game development environment enables automatic deployment on a plurality of different gaming platforms based on predefined device profiles.

The collaborative game development system 100 comprises a first local network 110-a connecting a first plurality of developer clients 112-a at a first location and a second local network 110-b connecting a second plurality of developer clients 112-b at a second location. Each of the developer clients 112 is coupled with a local database 114. The local database 114 may be stored, for example, in a storage device directly attached to a developer client 112 or elsewhere on the local network 110. In some embodiments, one or more of the local databases 114 may be shared among two or more developer clients 112 on the same local network 110. In one embodiment, the local databases 114 use a no-SQL database that uses a concept of documents rather than rows and tables. The first local network 110-a and the second local network 110-b are each coupled to a wide area network 120 (such as the Internet) to connect the first local network 110-a and the second local network 110-b to a master cloud services server 130. The master cloud services server 130 provides access to and controls a master content database 140, an asset file storage 150, and a master telemetry database 160 that are each accessible to each of the developer clients 112. In an embodiment, all network traffic for collaboration, asset sharing, and development telemetry pass through the master cloud services server 130. The master cloud services server 130 may provide services such as, for example, authentication, database storage, file storage and collaboration tools.

The asset file storage 150 stores binary data for digital assets used in the game under development. As used herein, an “asset” comprises a digital file or object representing game data. Examples of assets include scripts, meshes, animations, textures, shaders, audio files, etc. The asset file storage 150 additionally stores revisions to assets as they are being updated during development of the game.

The master content database 140 stores metadata associated with the game including notes about implementation, usage, materials, measurements, etc. The information dictates where, how, and when objects appear in the game, and contains all world, level, execution, and packaging data. The master content database 140 furthermore stores a history of all revisions made to the game under development and project data including changes to executable code, metadata, and other components for the game under development. In one embodiment, the master content database 140 stores associations between digital assets and various metadata. The master content database 140 may indicate, for example, how certain assets are being applied in the game under development (e.g., what textures are applied to a given object, what level and location the object appears, characteristics associated with the asset, etc.). In one embodiment, the master database 130 use a no-SQL database that uses a concept of documents rather than rows and tables.

The master telemetry database 160 stores all telemetry data from development. The telemetry data may include, for example, a number of assets submitted by an individual developer, time spent developing assets, changes made to the asset (placement, scale, physics, etc.), notes added by a developer, assets imported, etc. The tracked telemetry thus indicates what actions were performed by different developers during development of the game, how long the actions took, when the actions were taken, and who took the actions. Such tracking enables a manager to access information describing all changes made to the game by various developers throughout all stages of development. The master telemetry database 160 also stores gameplay data such as player data, information about how, where, and when the game is played, level completion information, device information, how the players played, what gameplay decisions were made, etc.

The collaborative game development system 100 beneficially facilitates real-time collaborative game development and enables game developers to track every change made to the game during development, such as, for example, importing assets, changing positions of assets, writing scripts, etc.). In order to ensure that changes made to an asset or newly imported assets from one developer client 112 are propagated to other developer clients 112, the developer client 112 making the change or import checks whether the asset already exists and modifies the corresponding local database 110 to log the change or import. The developer client 112 creates and stores a log detailing the differences made (delta) by that developer client 112 from the last state of the project. Each local project database 110 is selectively synced with the master content database 140 and so that changes made at one developer client 112 are propagated to the master content database 140, which is in turn synchronized to other local databases 114 for other clients 112.

A benefit of the distributed architecture of FIG. 1 is that the local databases 114 enables the developer clients 112 to work offline and distribute the load. Synchronizations to the master database 140 can be done when the master database 140 is available or when otherwise convenient. The provided architecture supports a branching structure, so that normal operation (one or a few developers working in the same branch) do not cause contention with others. Merging may be done when the project directors determine it is tune, rather than constantly. The architecture of FIG. 1 also enables resolution of resolve granular pieces of assets to both avoid merge conflicts and allow developers to work together without conflicts.

The database foundation of the collaborative game development environment 100 enables developers to develop, package and publish games to multiple platforms with optimized runtime (based on platform profiles) simultaneously, thus improving efficiency and time to market. Platform profiles may include profiles for platforms such as, for example, a PC, a mobile device, a tablet, a game console. Additional profiles may be included for particular operating systems e.g., APPLE OSX, APPLE iOS, ANDROID, WINDOWS, etc.), or particular game consoles (e.g., XBOX, NINTENDO, PLAYSTATION, etc.). In one embodiment, each platform profile specifies platform-specific modification rules for modifying assets being deployed to the corresponding platform. In one embodiment, the platform-specific modification rules include both developer-specified platform-specific rules that are editable by the developer and immutable platform-specific rules that cannot be changed by the developer. The developer-specified portions may specify characteristics of assets that are not necessarily required by the platform, but are specified by the developer for that platform at the developer's discretion. The immutable portions of the profile may specify characteristics that are not developer-editable and are always applied (and may be required) for that particular platform.

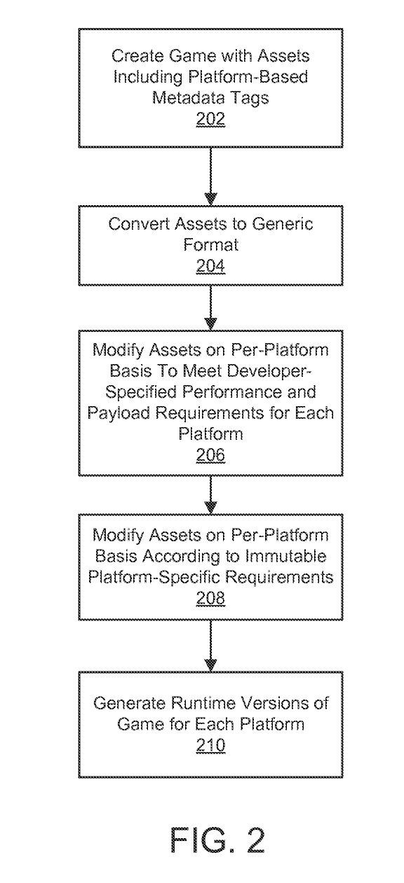

FIG. 2 illustrates an embodiment of a process for deploying a game to multiple platforms in the collaborative game development environment 100. Using the developer clients 112, developers collaboratively create 202 a game, resulting in the master content database 140 being populated with all of the game assets. During the game creation process, the developer clients 112 tags each asset as it is imported with platform-based metadata. For example, each asset is tagged with a platform type (e.g. tablet, smartphone, HD tablet, PC, console) for which the asset is intended. Furthermore, each asset may be tagged to indicate which other assets for different platforms it relates to. For example, a 3D car model asset tagged for deployment on a mobile platform might have 10 k polygons while a related car model asset tagged for a game console platform has 100 k polygons. In another example, scripts may be tagged so that they only apply to a particular platform and do not apply to other platforms. Each of these assets has a tag indicating the respective platform for which it is intended and a tag to indicate an association to the corresponding asset on the other platform(s).

The master cloud services server 130 converts 204 the assets to a generic format. For example, in one embodiment, the assets are converted from a format native to an original digital content creation tool (DCC) to a custom format used in the collaborative game development system. The master cloud services server 130 modifies 206 the assets (if needed) based on a plurality of different platform profiles to meet developer-specified performance and payload requirements specific to each platform. This generates a plurality of parallel data sets, each corresponding to a different platform for publishing. In this step, to prepare assets for a particular platform, assets are first selected that are already tagged for that particular platform. The assets may then be further modified if needed to meet platform profile requirements specified by the developer as specified in developer-specified platform-specific rules. For example, the developer may specify a set of rules that dictate limitations or other characteristics for assets on each particular platform (e.g., limits on texture size, formats, etc.) For example, asset features that result in higher performance attributes may be specified a game console version of the game than a mobile device version, which will operate with lower processing speeds, memory, etc. As a result, assets targeted for the mobile device version may be modified to limit, for example, texture size and polygon density. In a first specific example, a platform profile for a particular platform may include a developer-specified requirement that enforces a maximum texture size of 256×256 for any assets deployed for that platform for performance considerations. All assets processed by the platform profile are checked for this requirement and assets that do not meet the requirement are reduced in size. For example, a texture asset that is originally 1024×1024 in size is reduced in to 256×256 In one embodiment, an entry indicating the failure is written to a log.

In a second specific example, rather than automatically modifying the asset, an error may be logged and the developer notified to fix the asset to conform to the requirement. For example, a platform profile for a particular platform may include a developer-specified requirement that enforces that character polygon mesh models only have 1000 triangles for performance considerations. All assets processed by this project profile are checked for this requirement, and assets that do not meet that requirement are logged as errors and processing stops. The asset is then repaired and reintroduced by the developer before processing continues. For example, if a character polygon mesh model asset is introduced that that is 25,000 triangles in size, an error is logged and processing does not continue until the asset is recreated to and meets the requirement.

In yet another example, as script can be converted between formats (e.g., between GLES2 and GLES3 formats) to generate code specific to platform-compatible code specified by the developer in the platform profiles.

Each version of the data for each platform is also modified 208 according to immutable platform-specific requirements specified in a platform profile. In this step, rather than enforcing developer-specified limitations or characteristics, the assets are modified to ensure that the assets meet immutable requirements of a particular platform based on the immutable platform-specific rules.

In a first example, the immutable platform-specific rules specify that for Android devices that will render with OpenGLES version 2.0 require that in order to use alpha while rendering, the color and alpha textures must be separate assets. All texture assets are checked for this requirement, and assets that do not meet the requirement are logged. A developer may then recreate the asset in order to ensure that it achieves this requirement. For example, if a color texture asset is introduced that contains an alpha channel., the server 130 applies an Android platform profile to detect that the alpha channel is present within the color texture and there is no corresponding separate alpha texture. The asset entry is rejected. An error entry is made into the log and processing does not continue until the developer recreates the asset.

In another example, an Apple IOS platform profile specifies that textures be square in dimension such that height and width are equal. All texture assets are checked for this requirement, and assets that do not meet the requirement are logged. A developer may recreate the assets to achieve this requirement before processing continues. For example, if a texture asset is introduced that has dimensions of 1024×350, the server applies the Apple IOS device profile to detect that the texture is not square. The asset entry is rejected. An error entry is made into the log and processing does not continue until the asset is recreated to meet the requirement.

In yet another example, a platform profile for a particular platform may specify a maximum texture size of 128×128. An asset that is 1024×1024 in size is reduced in this step to 128×128. In another example, code can be converted between formats (e.g., between GLES2 and GLES3 formats) to generate code specific to platform-compatible code specified in the platform profiles.

Runtime versions of the game are then generated 210 for each platform. This creates separate optimized runtime packages for different platforms such as, console, tablet, phone, PC, etc. based on tagged assets and device profiles.

This process of FIG. 2 beneficially alleviates much of the duplicated effort in deploying the same game to many different devices/platforms. In addition, robust device profiles allow developers to continually test their project on multiple platforms during development, allowing early testing avoiding incompatibilities or other problems at the time of compile.

In one embodiment, the collaborative game development system 100 supports efficient computer processor (CPU) utilization across multiple CPU cores with functionally asynchronous rendering. The processing of assets described in FIG. 2 above is time consuming across multiple platforms and distributing this processing across available CPU cores may reduce the time to process by a factor ten or more, thus speeding up development. Multi-stage data parallelism extends the idea of data parallel execution to add in additional controls for order of execution. This is achieved through staging the order of execution. Any job in a given stage of execution can occur in random order. However everything in stage N is guaranteed to complete before stage N+1 begins executing, allowing efficient CPU utilization with minimal resource contention. Additionally, the system 100 queues up an additional frame of information (R+1) while the previous frame of simulation is rendering further leveraging the CPU and decoupling execution dependencies.

In an embodiment, the collaborative game development system 100 enables multiple threading by layering a control system into a simple low level linear task model which issues larger groupings of tasks. The low level linear task model also provides for the fencing which can make sure all prior tasks have completed prior to moving on to further tasks. In one example, a first instruction issues ‘n’ divided by the number of works to each thread in the system. The second instruction waits for all threads to complete working before moving on.

Given three task groups called here ‘a’, ‘b’ and ‘c’, there are several options as to how they interact. In on embodiment, all three sets of tasks are issued with a fence in between each such that all of ‘a’ is complete before any of ‘b’ begins processing. Issuing the fences is under control of the developer. If the developer determines that tasks ‘a’ and ‘b’ can run together, simply removing the first fence instruction will greatly reduce the idle time. Without the fence, cores which finish tasks from group ‘a’ immediately start on tasks from group ‘b’ without delay. Through this high level ability to reorganize task flow, large scale optimization is possible.

Additional distribution types can be implemented as instructions to the control flow such as lazy hierarchical task issuance for things such as hierarchical culling, specified thread counts can be used in some tasks which only distribute n-ways and many further extensions become possible. The core of controlling thread synchronization and task distribution allows this greater flexibility and much higher performing solution than existing systems.

[PU140043] In order to facilitate the deployment to multiple platforms as described above in the process of FIG. 2, it is desirable to properly segment assets and updates. The collaborative game development system 100 also allows developers to push asset updates without having to re-submit the core game and allows for automatic tracking and “hot swapping” of all assets. Every asset may be automatically tagged and stored in an authoring database. The runtime executable may draw content from a local database 114 which receives updates from the master content database 130 and can therefore push unique content to different users (enabling multi-variant A/B testing) and updates to existing content; e.g. scripting fixes, asset swapping, etc. The present system allows multiple users to be editing the same scene without conflicts by connecting to the master database 130 which holds granular detail of assets.

[PU140048] In one embodiment, the system 100 optimizes storage and network bandwidth by de-duplicating persistent data. Due to integrated version control, once data is saved to the database, it preferably persists forever. Fields within documents that are bulk data can have a bulk data handle associated with them. That bulk data handle may be a unique identifier that can allow lookup of the bulk data within a repository or cache. The client 112 may not try to fetch the bulk data for a given handle; in that case, the file contents are not transmitted over the network nor stored on the client 112, and no resources are wasted. If the bulk data contents are necessary but not available within the cache on the client 112, the client 112 can request that bulk data field from the server; the server will then transmit a stored MD5 signature and pre-compressed copy of that data to the client 112, at which point the client 112 can store that data into its cache with the corresponding bulk data handle. The client 112 can then look up the compressed bulk data in its cache and decompress it to get the original field contents.

The client 112 may treat its bulk data collection as a cache and evict data that has not been retrieved in a specified time period in order to minimize local storage requirements. For any bulk data desired to send from the client to the server, the client 112 may calculate the MD5 cryptographic signature of the data. The client 112 can then inspect its local cache of bulk data for the MD5 and see if it might have the data present. Because cryptographic signatures cannot be guaranteed to not collide, the new data is compared to the preexisting data. If the signature matched and the data compared equally, instead of transmitting the data to the server 130, the client 112 can just send the handle associated with that bulk data. If the client 112 does not find that data in its local cache, the client 112 compresses the data and send both the MD5 signature and the compressed field contents to the server 130. The server 130 may then see if it has that data in its repository in the same fashion as the client 112 used for looking up that data in the cache; however, the server 130 may be able to compare the compressed data instead of uncompressed for efficiency if the compression algorithm used is deterministic and the same compression parameters are used. If matching data was not found, the server 130 may create a new entry for the bulk data, store the compressed data and signature to be associated with the handle, and return that handle to the client 112; otherwise the server 130 returns the preexisting matching bulk data handle. When the client 112 receives the bulk data handle, whether new or preexisting, it may store the associated MD5 and compressed data with the bulk data handle into its cache. Specifically, the MD5 signature calculation and data compression may occur only on the client 112 to minimize load on the server 130, as well as to guarantee the data was correctly transmitted over the network.

In one embodiment, the system 100 facilitates this form of data de-duplication by making sure that data is written out in a consistent and well-ordered manner such that multiple attempts to save the same data generate bitwise-identical output. For instance, if the data represented vertex positions, the data may be sorted based on x,y,z positions so that repeated exports of the same mesh positional data will match the first export and repeatedly collapse to a single bulk data object. When applied across an entire mesh, this approach facilities maximum data sharing between revisions of a mesh when only portions of it change.

### Computing Machine Architecture

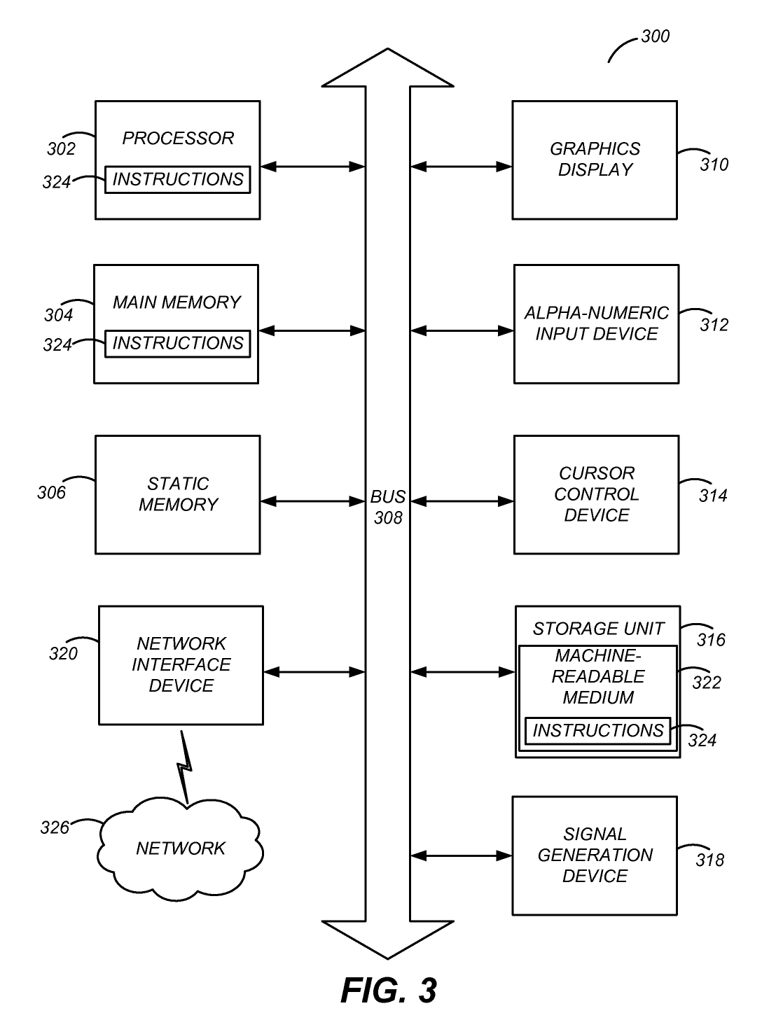

FIG. 3 is a block diagram illustrating components of an example machine (e.g., a computer) able to read instructions from a non-transitory machine-readable storage medium and execute them in a processor (or controller). The depicted machine or variations thereof may be used as the developer client 112, the master cloud services server 130, or other computing devices described herein. Specifically, FIG. 3 shows a diagrammatic representation of a machine in the example form of a computer system 300 within which instructions 324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include graphics display unit 310 (e.g., a plasma display panel (PDP), a liquid crystal display (LCD), a projector, or a cathode ray tube (CRT)). The computer system 300 may also include alphanumeric input device 312 (e.g., a keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 302, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for the described embodiments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

What is claimed is:

1. A method for deploying an electronic game to multiple gaming platforms, the method comprising:
receiving, at a server, a plurality of digital assets associated with an electronic game, each of the digital assets in a format native to a digital content creation tool;
converting, by the server, the plurality of digital assets from the format native to the digital content creation tool to a generic format;
receiving, at the server, a plurality of platform profiles, each of the platform profiles associated with respective different types of platforms for deploying the electronic game, and each of the platform profiles specifying platform-specific modification rules for modifying the plurality of digital assets;
modifying, by the server, the plurality of digital assets according to each of the platform-specific modification rules to generate a plurality of sets of modified digital assets, each of the sets associated with one of the different types of platforms for deploying the electronic game;
generating a plurality of runtime versions of the electronic game, each of the plurality of runtime versions using a corresponding one of the sets of the plurality of assets, each of the runtime versions associated with one of the different types of platforms for deploying the electronic game.

2. The method of claim 1, wherein each of the digital assets having a metadata tag indicating one or more platforms associated with the digital asset, wherein the sets of the plurality of assets each include only a subset of the plurality of assets that have a metadata tag indicating the corresponding platform.

3. The method of claim 1, wherein modifying the plurality of digital assets comprises:
modifying the plurality of assets according to developer-specified platform-specific rules editable by a developer.

4. The method of claim 1, wherein modifying the plurality of digital assets comprises:
modifying the plurality of assets according to immutable platform-specific rules that cannot be edited by the developer.

5. The method of claim 1, wherein modifying the plurality of digital assets comprises:
for a given platform profile, reducing a size of one or more assets to a predefined maximum size specified in the given platform profile.

6. The method of claim 1, wherein modifying the plurality of digital assets comprises:
for a given platform profile, converting a format of one or more assets to a predefined format specified in the given platform profile.

7. The method of claim 1, wherein the different types of platforms include at least one of: a PC platform, a game console platform, a mobile device platform, and a tablet platform.

8. A non-transitory computer-readable storage medium storing instructions for deploying an electronic game to multiple gaming platforms, the instructions when executed by a processor causing the processor to perform steps including:
receiving a plurality of digital assets associated with an electronic game, each of the digital assets in a format native to a digital content creation tool;
converting the plurality of digital assets from the format native to the digital content creation tool to a generic format;
receiving a plurality of platform profiles, each of the platform profiles associated with respective different types of platforms for deploying the electronic game, and each of the platform profiles specifying platform-specific modification rules for modifying the plurality of digital assets;
modifying the plurality of digital assets according to each of the platform-specific modification rules to generate a plurality of sets of modified digital assets, each of the sets associated with one of the different types of platforms for deploying the electronic game; and
generating a plurality of runtime versions of the electronic game, each of the plurality of runtime versions using a corresponding one of the sets of the plurality of assets, each of the runtime versions associated with one of the different types of platforms for deploying the electronic game.

9. The non-transitory computer-readable storage medium of claim 8, wherein each of the digital assets having a metadata tag indicating one or more platforms associated with the digital asset, wherein the sets of the plurality of assets each include only a subset of the plurality of assets that have a metadata tag indicating the corresponding platform.

10. The non-transitory computer-readable storage medium of claim 8, wherein modifying the plurality of digital assets comprises:
modifying the plurality of assets according to developer-specified platform-specific rules editable by a developer.

11. The non-transitory computer-readable storage medium of claim 8, wherein modifying the plurality of digital assets comprises:
modifying the plurality of assets according to immutable platform-specific rules that cannot be edited by the developer.

12. The non-transitory computer-readable storage medium of claim 8, wherein modifying the plurality of digital assets comprises:
for a given platform profile, reducing a size of one or more assets to a predefined maximum size specified in the given platform profile.

13. The non-transitory computer-readable storage medium of claim 8, wherein modifying the plurality of digital assets comprises:
for a given platform profile, converting a format of one or more assets to a predefined format specified in the given platform profile.

14. The non-transitory computer-readable storage medium of claim 8, wherein the different types of platforms include at least one of: a PC platform, a game console platform, a mobile device platform, and a tablet platform.

15. A system for deploying an electronic game to multiple gaming platforms comprising:
a processor; and
a non-transitory computer-readable storage medium storing instructions for deploying an electronic game to multiple gaming platforms, the instructions when executed by the processor causing the processor to perform steps including:
receiving a plurality of digital assets associated with an electronic game, each of the digital assets in a format native to a digital content creation tool;
converting the plurality of digital assets from the format native to the digital content creation tool to a generic format;
receiving a plurality of platform profiles, each of the platform profiles associated with respective different types of platforms for deploying the electronic game, and each of the platform profiles specifying platform-specific modification rules for modifying the plurality of digital assets;
modifying the plurality of digital assets according to each of the platform-specific modification rules to generate a plurality of sets of modified digital assets, each of the sets associated with one of the different types of platforms for deploying the electronic game; and
generating a plurality of runtime versions of the electronic game, each of the plurality of runtime versions using a corresponding one of the sets of the plurality of assets, each of the runtime versions associated with one of the different types of platforms for deploying the electronic game.

16. The system of claim 15, wherein each of the digital assets having a metadata tag indicating one or more platforms associated with the digital asset, wherein the sets of the plurality of assets each include only a subset of the plurality of assets that have a metadata tag indicating the corresponding platform.

17. The system of claim 15, wherein modifying the plurality of digital assets comprises:
modifying the plurality of assets according to developer-specified platform-specific rules editable by a developer.

18. The system of claim 15, wherein modifying the plurality of digital assets comprises:
modifying the plurality of assets according to immutable platform-specific rules that cannot be edited by the developer.

19. The system of claim 15, wherein modifying the plurality of digital assets comprises:
for a given platform profile, reducing a size of one or more assets to a predefined maximum size specified in the given platform profile.

20. The system of claim 15, wherein modifying the plurality of digital assets comprises:
for a given platform profile, converting a format of one or more assets to a predefined format specified in the given platform profile.
